(19) United States
(12) Patent Application Publication
(10) Pub. No.: US 2014/0072475 A1
(43) Pub. Date: Mar. 13, 2014

(54) PROTEIN ASSAY APPARATUS

(71) Applicant: MAESTROGEN INC., Hsinchu City (TW)

(72) Inventors: KUAN-HSIUNG WANG, HSINCHU CITY (TW); SHUO-TING YAN, HSINCHU CITY (TW); YUEH-CHU TIEN, HSINCHU CITY (TW); JU-CHIN TSAI, HSINCHU CITY (TW); KAI-LUN YANG, HSINCHU CITY (TW)

(73) Assignee: MAESTROGEN INC., Hsinchu City (TW)

(21) Appl. No.: 13/870,148

(22) Filed: Apr. 25, 2013

(30) Foreign Application Priority Data
Sep. 10, 2012 (TW) 101133061

(51) Int. Cl. G01N 21/78

(52) U.S. Cl. CPC G01N 21/78
USPC 422/82.09

(57) ABSTRACT

A protein assay apparatus includes at least one light-emitting unit for generating a first light, a second light or a third light for BCA protein assay, Bradford protein assay or Lowry protein assay, and at least one light-sensing unit for sensing the absorbed light passed through the test sample to calculate the concentration of protein in the test sample. This design shortens the protein examination time and greatly reduces the protein examination cost.

### BACKGROUND OF THE INVENTION

1. Technical Field

The present invention relative to a device for measuring the concentration of protein in a sample solution and more particularly, to a protein assay apparatus that shortens the protein examination time and lowers the protein examination cost.

2. Description of the Prior Art

Protein is a biochemical compound consisting of one or more polypeptides typically folded into a globular or fibrous form, facilitating a biological function. Protein quantitative analysis is an important work in medicine, pharmacy, biochemistry, biology, food or cosmetics.

Change in light intensity is used to calculate the optical density value of the sample solution to be tested in a predetermined optical pathlength, i.e. the absorbance of the solution in the optical pathlength. Their relationship is as the following equation:

O.D.=A≡−Log(T)=−Log(I/Iₒ)

in which, A is the absorbance of the sample solution; T is the transmittance of the sample solution; I and Iₒ are the intensities of the light passing through the test sample and the reference sample Calculation is based on the absorbance of light of a liquid in a 10 mm wide quartz tube. The light intensity measured during the test is converted into absorbance, and then calculated with the reference optical pathlength 10 mm using the equation of Beer-Lambert Law, and thus the absorbance of the sample solution at the optical pathlength 10 mm is obtained.

Bill Lambert law relates the absorption of light to the properties of the material through which the light is travelling. When emitting a light onto an absorption medium, the medium will absorb a part of the emitted light, the intensity of the light will diminish, wherein the absorbance of the medium is directly proportional to the optical pathlength, and the equation is as follows:

Aₓ/A_{y}=Pₓ/P_{y}

in which, A is the absorbance of the test sample, P is the optical pathlength, x and y respectively represent two optical pathlengths.

The concentration (c), the optical pathlength (P) and the absorbance (A) show the relationship of:

c=(A×e)/P

in which, e is the extinction coefficient.

According to the aforesaid principle, when measuring the concentration of protein in a test sample (test solution), the test sample is filled in a quartz tube, and then a spectrophotometer is used to measure the transmittance in a full-spectrum manner. The transmittance is then converted into absorbance for estimating the concentration of protein in the test sample.

However, due to the radiation of the emitted light, the protein may deteriorate after the assay. Further, it is difficult to clean the rectangular test tube. The rectangular test tube is usually discarded after the assay.

Directly discarding the test tube after the assay eliminates the inconvenience of cleaning the test tube and avoids residual protein solution in the test tube due to improper cleaning. However, a rectangular test tube has a high cost. It is neither economic nor environmentally friendly to discard the test tube after the assay.

Further, conventional protein assay apparatuses commonly use full-spectrum lamp tubes to emit light. These full-spectrum lamp tubes need a warm-up time before the assay, causing inconvenience.

### SUMMARY OF THE PRESENT INVENTION

It is, therefore, the main object of the present invention to provide a protein assay apparatus, which eliminates the use of a full-spectrum light-emitting unit for measuring the concentration of protein in a test sample, shortening the protein assay time and lowers the protein assay apparatus installation cost.

It is another object of the present invention to provide a protein assay apparatus, which uses one or a plurality of light-emitting units to emit light in the range of 552 nm˜572 nm, 585 nm˜605 nm, or 650 nm˜670 nm for measuring the concentration of protein in a test sample using BCA protein assay, Bradford protein assay or Lowry protein assay.

It is still another object of the present invention to provide a protein assay apparatus, which emits a green light, yellow light or red light onto a test sample for measuring the concentration of protein in a test sample using BCA protein assay, Bradford protein assay or Lowry protein assay.

It is still another object of the present invention to provide a protein assay apparatus, which uses a first transparent plate and a second transparent plate to hold a test sample therebetween instead of the use of a rectangular test tube, enabling the test sample to form a liquid column between the first transparent plate and the second transparent plate for measuring the concentration of protein, facilitating cleaning and lowering the protein assay cost.

To achieve the above mentioned and other objectives, the present invention provides a protein assay apparatus, comprising: a plurality of light-emitting units adapted to respectively emit a first light, a second light and a third light onto a test sample, wherein said first light is a green light, said second light is a yellow light, and said third light is a red light; at least one light-sensing unit adapted to receive a first absorbed light, a second absorbed light or a third absorbed light and to measure the intensity of said first absorbed light, said second absorbed light or said third absorbed light, wherein said test sample absorbs part of said first light, said second light or said third light to generate said first absorbed light, said second absorbed light or said third absorbed light; and an arithmetic logic unit electrically connected to said light-sensing units and adapted to convert the intensity of said first absorbed light, said second absorbed light or said third absorbed light being measured by said light-sensing units into a value indicative of the concentration of protein in said test sample.

The present invention further provides a protein assay apparatus, comprising: a light-emitting unit controllable to emit a first light, a second light or a third light onto a test sample, wherein said first light is a green light, said second light is a yellow light, and said third light is a red light; a light-sensing unit adapted to receive a first absorbed light, a second absorbed light or a third absorbed light and to measure the intensity of said first absorbed light, said second absorbed light and said third absorbed light, wherein said test sample absorbs part of said first light, said second light or said third light to generate said first absorbed light, said second absorbed light or said third absorbed light; and an arithmetic logic unit electrically connected to said light-sensing unit and adapted to convert the intensity of said first absorbed light, said second absorbed light and said third absorbed light being measured by said light-sensing unit into a value indicative of the concentration of protein in said test sample.

In one embodiment of the protein assay apparatus, wherein the number of said light-emitting units is 3 and these three light-emitting units are adapted to emit said first light, said second light and said third light respectively, and one of these three light-emitting units is selected to emit one of said first light, said second light and said third light at one time point.

In one embodiment of the protein assay apparatus, wherein said first light has a wavelength in the range of 552 nm˜572 nm; said second light has a wavelength in the range of 585 nm˜605 nm; said third light has a wavelength in the range of 650 nm˜670 nm.

In one embodiment of the protein assay apparatus, further comprising at least one optical fiber connected to said light-emitting units.

In one embodiment of the protein assay apparatus, further comprising a light outlet element connected to said light-emitting units through said at least one optical fiber.

In one embodiment of the protein assay apparatus, further comprising a first carrier carrying said light-emitting units, and a second carrier carrying said at least one light-sensing unit corresponding to said light-emitting units at said first carrier.

In one embodiment of the protein assay apparatus, further comprising a first transparent plate located at said first carrier and covering said light-emitting units, and a second transparent plate located at said second carrier and covering said at least one light-sensing unit.

In one embodiment of the protein assay apparatus, further comprising a first carrier and a second carrier, said first carrier and said second carrier being disposed corresponding to each other.

In one embodiment of the protein assay apparatus, further comprising a light outlet element and a light inlet element, said light outlet element being located at said first carrier and connected to said light-emitting units by at least one first optical fiber, said light inlet element being located at said second carrier and connected to said at least one light-sensing unit by at least one second optical fiber.

In one embodiment of the protein assay apparatus, further comprising a first transparent plate and a second transparent plate, said first transparent plate being located at said first carrier and covering said light outlet element, said second transparent plate being located at said second carrier and covering said light inlet element.

In one embodiment of the protein assay apparatus, wherein said test sample is placed between said first transparent plate and said second transparent plate.

### BRIEF DESCRIPTION OF THE DRAWINGS

FIG. 1 is a schematic drawing illustrating the architecture of a protein assay apparatus in accordance with a first embodiment of the present invention.

FIG. 2 is a schematic drawing illustrating the architecture of a protein assay apparatus in accordance with a second embodiment of the present invention.

FIG. 3 is a schematic drawing illustrating the architecture of a protein assay apparatus in accordance with a third embodiment of the present invention.

FIG. 4 is a schematic drawing illustrating the architecture of a protein assay apparatus in accordance with a fourth embodiment of the present invention.

FIG. 5 is a schematic drawing illustrating the architecture of a protein assay apparatus in accordance with a fifth embodiment of the present invention.

FIG. 6 is a schematic drawing illustrating the architecture of a protein assay apparatus in accordance with a sixth embodiment of the present invention.

### DETAILED DESCRIPTION OF THE PREFERRED EMBODIMENTS

In the following description of the present invention, it is to be noted that the word “connection” means direct or indirect connection between or among objects or components, for example, connector means can exist between or among objects or components.

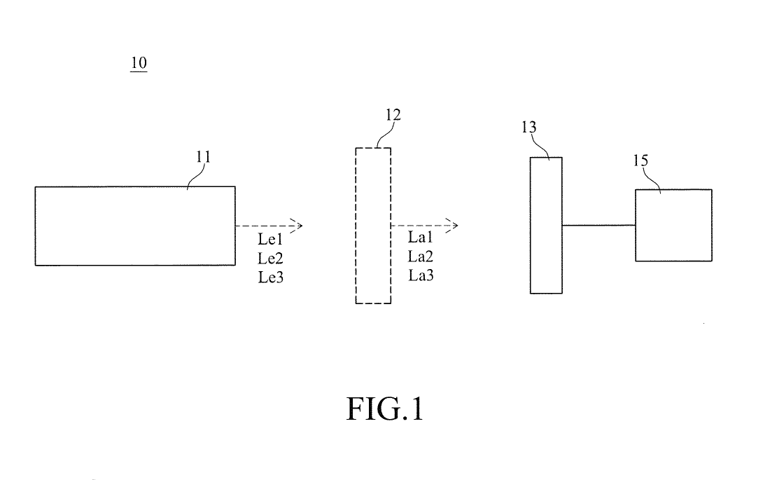

Referring to FIG. 1, a protein assay apparatus in accordance with a first embodiment of the present invention is shown. As illustrated, the protein assay apparatus 10 comprises a light-emitting unit 11, a light-sensing unit 13, and an arithmetic logic unit 15. The light-emitting unit 11 is controllable to emit a first light Le1, a second light Le2, or a third light Le3. Further, in this first embodiment, the first light Le1 is a green light, the second light Le2 is a yellow light, and the third light Le3 is a red light.

In actual application, the test sample 12 is placed between the light-emitting unit 11 and the light-sensing unit 13, and then the light-emitting unit 11 is controlled to emit light Le1/Le2/Le3 onto the test sample 12, enabling the absorbed light La1/La2/La3 that passed through the test sample 12 to be projected onto the light-sensing unit 13. For example, the test sample 12 absorbs a part of the first light Le1, second light Le2 or third light Le3 to generate a first absorbed light La1, second absorbed light La2 or third absorbed light La3 that is then received by the light-sensing unit 13. In order to improve the convenience of use, an optical fiber can be connected to the light-emitting unit 11 to guide the emitted light Le1/Le2/Le3, enabling the emitted light Le1/Le2/Le3 to be projected onto the test sample 12. The light-sensing unit 13 can also be connected with an optical fiber. The method for connecting a respective optical fiber to the light-emitting unit 11 and the light-sensing unit 13 will be explained further.

The arithmetic logic unit 15 is electrically connected to the light-sensing unit 13 to estimate the concentration of protein in the test sample 12 subject to the intensity of the first absorbed light La1, second absorbed light La2 or third absorbed light La3 that is received by the light-sensing unit 13. In actual application, the arithmetic logic unit 15 calculates the absorbance of the optical pathlength subject to the intensity of the absorbed light that is received by the light-sensing unit 13, and then estimates the absorbance of a reference optical pathlength (for example, 10 mm) using the data of at least one optical pathlength stored in a databank (not shown) and calculates the concentration of protein in the test sample 12. Many conventional protein assays are known. The protein assay apparatus of the present invention is designed subject to the corresponding wavelengths of three known protein assays, i.e., (1) BCA protein assay, (2) Bradford protein assay and (3) Lowry protein assay. These three protein assays are briefly explained hereinafter.

BCA protein assay: The Thermo Scientific Pierce BCA Protein Assay remains one of the most popular protein quantitation methods worldwide. The BCA Protein Assay combines the well-known reduction of Cu²⁺ to Cu¹⁺ by protein in an alkaline medium with the highly sensitive and selective colorimetric detection of the cuprous cation (Cu¹⁺) by bicinchoninic acid. Firstly, the peptide bonds in protein reduce Cu²⁺ ions from the cupric sulfate to Cu⁺ (a temperature dependent reaction). The amount of Cu²⁺ reduced is proportional to the amount of protein present in the solution. Next, two molecules of bicinchoninic acid chelate with each Cu⁺ ion, forming a purple-colored product that strongly absorbs light at a wavelength of 562 nm. Thus measuring the absorbance at wavelength 562 nm can determine the total concentration of protein.

Bradford protein assay: The Bradford assay is a colorimetric protein assay based on the observation that the absorbance maximum for an acidic solution of Coomassie Brilliant Blue G-250 shifts from 465 nm to 595 nm when binding to protein occurs. Both hydrophobic and ionic interactions stabilize the anionic form of the dye, causing a visible color change.

Lowry protein assay: The Lowry protein assay is a biochemical assay for determining the total level of protein in a solution. This method combines the reactions of copper ions with the peptide bonds under alkaline conditions (the Biuret test) with the oxidation of aromatic protein residues. The Lowry method is based on the reaction of Cu⁺, produced by the oxidation of peptide bonds, with Folin-Ciocalteu reagent (a mixture of phosphotungstic acid and phosphomolybdic acid in the Folin-Ciocalteu reaction). The total protein concentration is exhibited by a color change of the sample solution in proportion to protein concentration, which can then be measured at 660 nm using colorimetric techniques.

In this embodiment, the light Le1/Le2/Le3 emitted by the light-emitting unit 11 is not a full-spectrum light source. The wavelength of the light Le1/Le2/Le3 emitted by the light-emitting unit 11 is determined subject to the aforesaid protein assays, for example, the wavelength of the light Le1/Le2/Le3 emitted by the light-emitting unit 11 can be within the range of 552 nm˜572 nm, 585 nm˜605 nm, or 650 nm˜670 nm.

In accordance with the present first embodiment, the wavelength of the first light Le1 is within the range of 552 nm˜572 nm, suitable for the application of the aforesaid BCA protein assay; the wavelength of the second light Le2 is within the range of 585 nm˜605 nm, suitable for the application of the aforesaid Bradford protein assay; the wavelength of the third light Le3 is within the range of 650 nm˜670 nm, suitable for the application of the Lowry protein assay. The aforesaid wavelength ranges of the first light Le1, the second light Le2 and the third light Le3 are simply an example of the present invention. Different wavelength ranges can be selected for the first light Le1, the second light Le2 and the third light Le3 to fit different quantitative protein analyses.

Because the light-emitting unit 11 does not generate a full-spectrum light source, the invention greatly saves the consumption of energy during examination and the examination cost. Further, using the light-sensing unit 13 saves the cost to install an expensive spectrophotometer and effectively shortens the examination time.

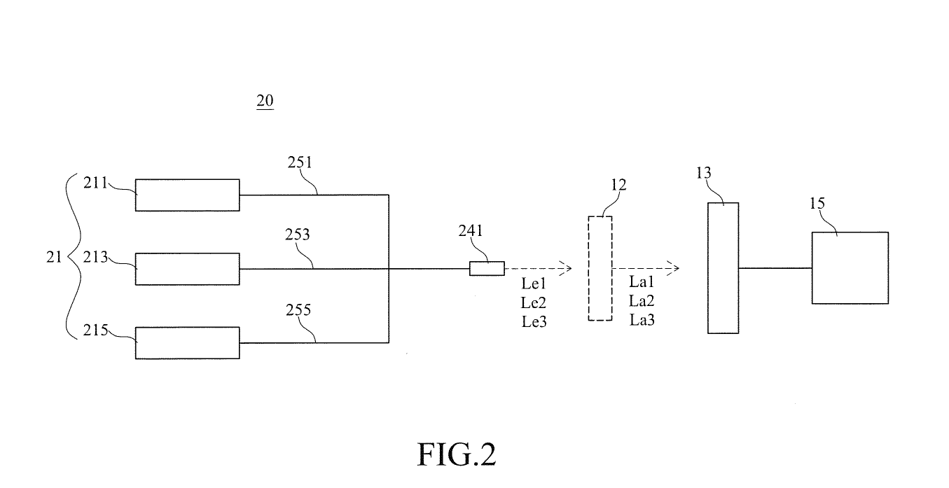

Referring to FIG. 2, a protein assay apparatus in accordance with a second embodiment of the present invention is shown. As illustrated, the protein assay apparatus 20 comprises a plurality of light-emitting units 21, a light-sensing unit 13, and an arithmetic logic unit 15. The number of the light-emitting units 21 can be 3, namely, the first light-emitting unit 211, the second light-emitting unit 213 and the third light-emitting unit 215. The first light-emitting unit 211 is adapted to emit a first light Le1. The second light-emitting unit 213 is adapted to emit a second light Le2. The third light-emitting unit 215 is adapted to emit a third light Le3.

In this second embodiment, the first light Le1 is a green light, the second light Le2 is a yellow light, and the third light Le3 is a red light. Further, in this second embodiment, the wavelength of the first light Le1 is within the range of 552 nm˜572 nm, the wavelength of the second light Le2 is within the range of 585 nm˜605 nm, and the wavelength of the third light Le3 is within the range of 650 nm˜670 nm. In actual application, at one same time point, only one single light-emitting unit 21 will emit light Le, for example, the first light Le1, the second light Le2 or the third light Le3.

Further, in one embodiment of the invention, the first light-emitting unit 211 has a first optical fiber 251 connected thereto, the second light-emitting unit 213 has a second optical fiber 253 connected thereto, and the third light-emitting unit 215 has a third optical fiber 255 connected thereto. In order to improve the convenience of use, the first optical fiber 251, the second optical fiber 253 and the third optical fiber 255 are coupled to one another. In one embodiment, a light outlet element 241 is connected to the first light-emitting unit 211, the second light-emitting unit 213 and the third light-emitting unit 215 through the first optical fiber 251, the second optical fiber 253 and the third optical fiber 255 respectively, enabling the first light Le1, the second light Let or the third light Le3 to pass through the light outlet element 241 onto the test sample 12.

In this second embodiment, three light-emitting units 21 are used. However, in actual application, the number of the light-emitting units 21 has a great concern with the quantitative protein determination method to be employed to the protein assay apparatus 20. Therefore, two, three or more than three light-emitting units 21 can be used to generate two, three or more than three light sources of different wavelengths to fit different quantitative protein determination methods. For example, the number of the light-emitting units 21 can be 5, wherein two light-emitting units 21 are adapted to emit two kinds of green light with different wavelengths, one light-emitting unit 21 is adapted to emit yellow light, and the other two light-emitting units 21 are adapted to emit two kinds of red light with different wavelengths.

Further, the light-emitting units 21 can be light-emitting diodes, laser structures, semiconductor laser structures, or their combinations for emitting proper wavelengths of light. Because the light-emitting units 21 are not full-spectrum lamp tubes, the invention greatly shortens the light source generating time.

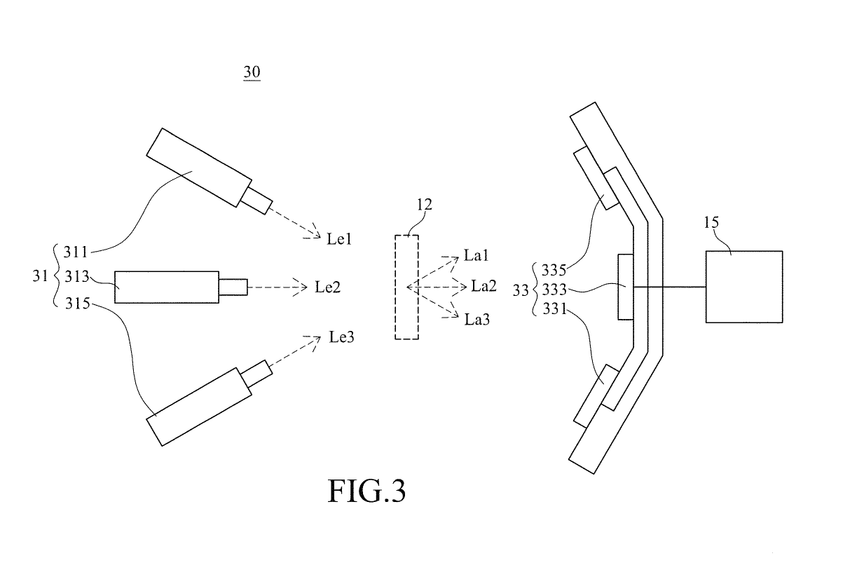

Referring to FIG. 3, a protein assay apparatus in accordance with a third embodiment of the present invention is shown. As illustrated, the protein assay apparatus 30 comprises a plurality of light-emitting units 31, a plurality of light-sensing units 33, and an arithmetic logic unit 15. The light-sensing units 33 are electrically connected to the arithmetic logic unit 15. The number of the light-emitting units 31 can be 3, namely, the first light-emitting unit 311, the second light-emitting unit 313 and the third light-emitting unit 315. The first light-emitting unit 311 is adapted to emit a first light Le1. The second light-emitting unit 313 is adapted to emit a second light Let. The third light-emitting unit 315 is adapted to emit a third light Le3. The number of the light-sensing units 33 can also be 3, namely, the first light-sensing unit 331, the second light-sensing unit 333 and the third light-sensing unit 335.

In one embodiment of the invention, the first light-emitting unit 311, the second light-emitting unit 313, the third light-emitting unit 315, the first light-sensing unit 331, the second light-sensing unit 333 and the third light-sensing unit 335 are arranged around the test sample 12, for example, the test sample 12 can be located in or near the center or the center of the circle of the aforesaid components.

In one embodiment of the invention, the location of the first light-emitting unit 311 corresponds to the location of the first light-sensing unit 331, and the test sample 12 is disposed between the first light-emitting unit 311 and the first light-sensing unit 331, wherein the first light-emitting unit 311 emits the first light Le1 onto the test sample 12, enabling the first absorbed light La1 that passed the test sample 12 to fall upon the first light-sensing unit 331. The location of the second light-emitting unit 313 corresponds to the location of the second light-sensing unit 333, and the test sample 12 is disposed between the second light-emitting unit 313 and the second light-sensing unit 333, wherein the second light-emitting unit 313 emits the second light Let onto the test sample 12, enabling the second absorbed light La1 that passed the test sample 12 to fall upon the second light-sensing unit 333. The location of the third light-emitting unit 315 corresponds to the location of the third light-sensing unit 335, and the test sample 12 is disposed between the third light-emitting unit 315 and the third light-sensing unit 335, wherein the third light-emitting unit 315 emits the third light Le3 onto the test sample 12, enabling the third absorbed light La3 that passed the test sample 12 to fall upon the third light-sensing unit 335.

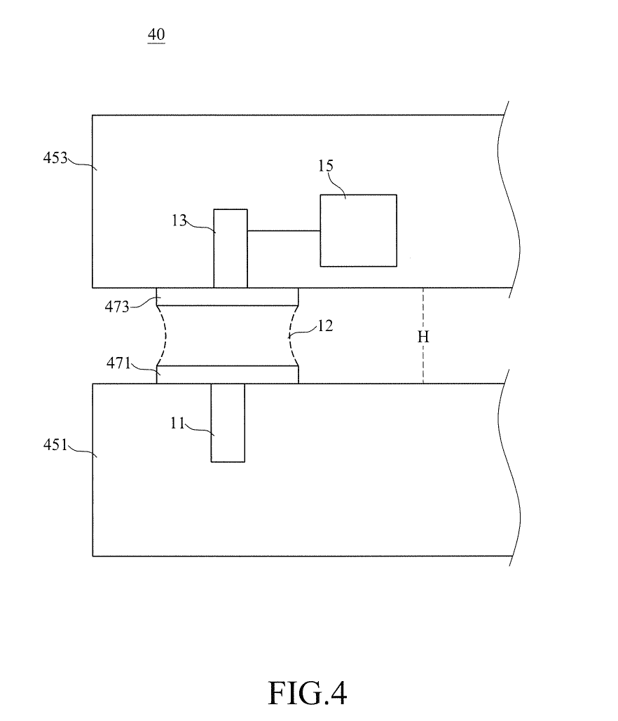

Referring to FIG. 4, a protein assay apparatus in accordance with a fourth embodiment of the present invention is shown. As illustrated, the protein assay apparatus 40 comprises a light-emitting unit 11, a light-sensing unit 13, an arithmetic logic unit 15, a first carrier 451, and a second carrier 453, wherein the light-emitting unit 11 is located at the first carrier 451, the light-sensing unit 13 is located at the second carrier 453, and the light-sensing unit 13 is electrically connected to the arithmetic logic unit 15.

The first carrier 451 and the second carrier 453 are disposed corresponding to each other such that the light-emitting unit 11 at the first carrier 451 is aimed at the light-sensing unit 13 at the second carrier 453. The test sample 12 is placed between the light-emitting unit 11 and the light-sensing unit 13, wherein the light Le1/Le2/Le3 emitted by the light-emitting unit 11 is projected onto the test sample 12, and the absorbed light La1/La2/La3 that passes through the test sample 12 will fall upon the light-sensing unit 13, enabling the light-sensing unit 13 to measure the intensity of the absorbed light La1/La2/La3.

In this fourth embodiment, the protein assay apparatus 40 further comprises a first transparent plate 471 and a second transparent plate 473. The first transparent plate 471 is located at the first carrier 451 and covers the light-emitting unit 11. The second transparent plate 473 is located at the second carrier 453 and covers the light-sensing unit 13. During examining the concentration of protein in a test solution (test sample) 12, the test solution (test sample) 12 is placed between the first transparent plate 471 and the second transparent plate 473. The test solution (test sample) 12 does not touch the light-emitting unit 11 and/or the light-sensing unit 13 directly, preventing the light-emitting unit 11 and/or the light-sensing unit 13 from being contaminated by the protein in the test solution (test sample) 12.

After the measurement, the user can clean the first transparent plate 471 and/or the second transparent plate 473 directly, or replace the first transparent plate 471 and/or the second transparent plate 473. The first transparent plate 471 and the second transparent plate 473 can be glass plates, quartz plates, or acrylic plates. Compared with rectangular test tubes, the first transparent plate 471 and the second transparent plate 473 have the advantages of ease of cleaning and low manufacturing cost. Using the first transparent plate 471 and the second transparent plate 473 can reduce the quantitative protein analysis cost.

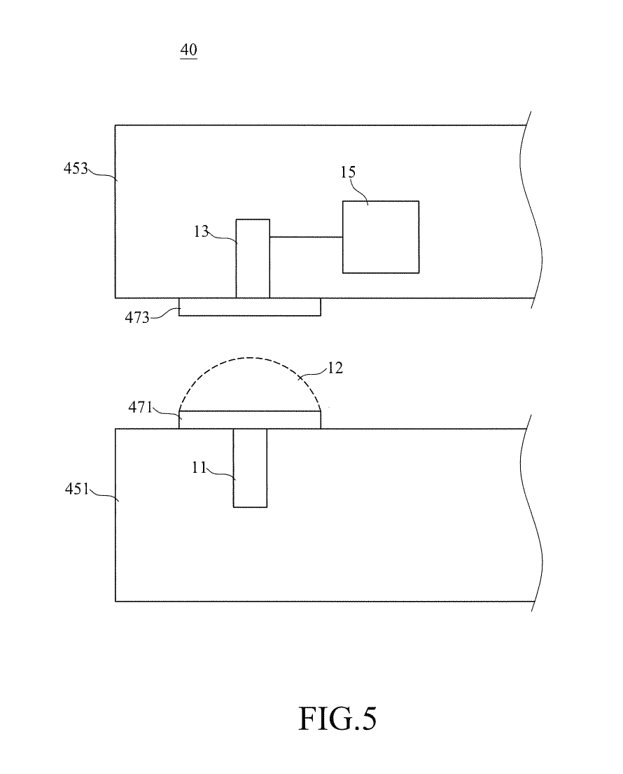

Further, the first carrier 451 and/or the second carrier 453 can be movable for allowing adjustment of the pitch H between the first carrier 451 and the second carrier 453. Allowing the user to adjust the pitch H between the first carrier 451 and the second carrier 453 facilitates the performance of the procedure to measure the concentration of protein in the test sample 12. For example, the user can increase the pitch H between the first carrier 451 and the second carrier 453, and then place the test solution (test sample) 12 on the light-emitting unit 11 and/or the first transparent plate 471, as shown in FIG. 5, and then shortens the pitch H between the first carrier 451 and the second carrier 453 to keep the light-sensing unit 13 and/or the second transparent plate 473 in contact with the test sample 12. At this time, the test sample 12 forms a liquid column between the first transparent plate 471 and the second transparent plate 473. During the quantitative protein assay, the height of the pitch H between the first carrier 451 and the second carrier 453 and the height of the liquid column are constant, facilitating the operation of the light-emitting unit 11 to emit the light Le1/Le2/Le3 onto the test sample 12 and the operation of the light-sensing unit 13 to receive the absorbed light La1/La2/La3 that passed through the test sample 12, as shown in FIG. 4.

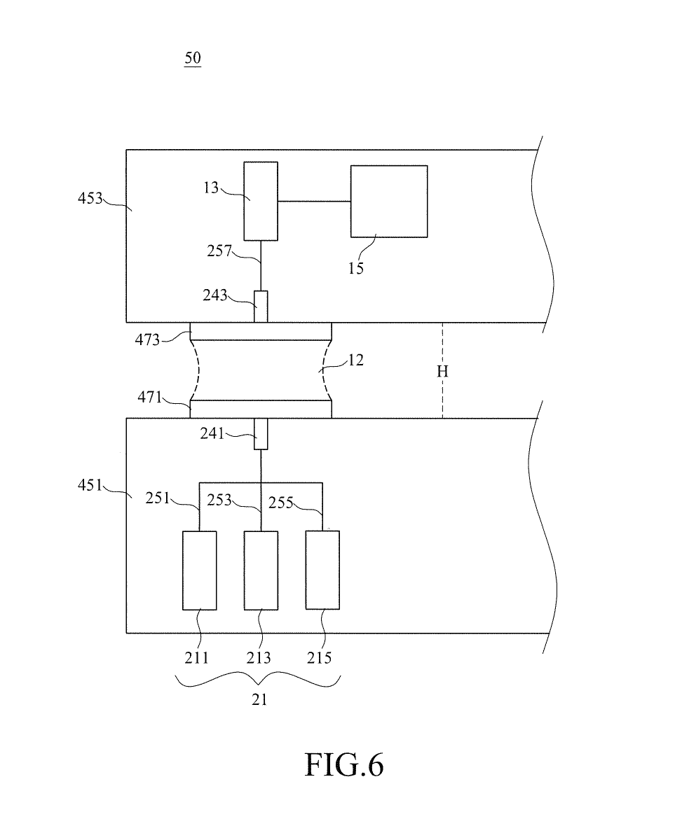

Referring to FIG. 6, a protein assay apparatus in accordance with a fifth embodiment of the present invention is shown. As illustrated, the protein assay apparatus 50 comprises a plurality of light-emitting units 21, a light-sensing unit 13, an arithmetic logic unit 15, a first carrier 451, and a second carrier 453, wherein the first carrier 451 and the second carrier 453 are disposed corresponding to each other, and the light-sensing unit 13 is electrically connected to the arithmetic logic unit 15.

In one embodiment of the invention, the number of the light-emitting unit 21 is 3, namely, the first light-emitting unit 211, the second light-emitting unit 213 and the third light-emitting unit 215. The first light-emitting unit 211, the second light-emitting unit 213 and the third light-emitting unit 215 are adapted to emit different wavelengths of light. For example, the first light-emitting unit 211 is adapted to emit a first light Le1 of wavelength within 552 nm˜572 nm. The second light-emitting unit 213 is adapted to emit a second light Le2 of wavelength within 585 nm˜605 nm. The third light-emitting unit 215 is adapted to emit a third light Le3 of wavelength within 650 nm˜670 nm. Further, at one same time point, only one single light-emitting unit 211/213/215 will emit light Le1/Le2/Le3.

Further, in one embodiment of the invention, the first light-emitting unit 211 has a first optical fiber 251 connected thereto, the second light-emitting unit 213 has a second optical fiber 253 connected thereto, and the third light-emitting unit 215 has a third optical fiber 255 connected thereto. In this embodiment, the protein assay apparatus 50 further comprises a light outlet element 241 and a light inlet element 243. The light outlet element 241 is located at the first carrier 451, and connected to the first light-emitting unit 211, the second light-emitting unit 213 and the third light-emitting unit 215 through the first optical fiber 251, the second optical fiber 253 and the third optical fiber 255 respectively. The light inlet element 243 is located at the second carrier 453, and connected to the light-sensing unit 13 through an optical fiber 257.

Further, the protein assay apparatus 50 also comprises a first transparent plate 471 and a second transparent plate 473. The first transparent plate 471 is located at the first carrier 451 and covers the light outlet element 241. The second transparent plate 473 is located at the second carrier 453 and covers the light inlet element 243. The light Le1/Le2/Le3 emitted by the first light-emitting unit 211, the second light-emitting unit 213 or the third light-emitting unit 215 passes through the first transparent plate 471 onto the test sample 12. The absorbed light La1/La2/La3 that passed through the test sample 12 passes through the second transparent plate 473 and falls upon the light inlet element 243.

The wording of “may”, “must” and “change” in the specification is not the limit of the present invention. The terminology used in the specification is for the description of particular embodiments of the invention but not intended as limitations of the invention. Single quantifier used in the specification (such as one of the unit) can also be plural, unless otherwise clearly described in the specification. For example, one device mentioned in the specification can be a combination of two or more of devices, and a substance mentioned in the specification can be a mixture of multiple substances.

What is claimed is:

1. A protein assay apparatus, comprising:
a plurality of light-emitting units adapted to respectively emit a first light, a second light and a third light onto a test sample, wherein said first light is a green light, said second light is a yellow light, and said third light is a red light;
at least one light-sensing unit adapted to receive a first absorbed light, a second absorbed light or a third absorbed light and to measure the intensity of said first absorbed light, said second absorbed light or said third absorbed light, wherein said test sample absorbs part of said first light, said second light or said third light to generate said first absorbed light, said second absorbed light or said third absorbed light; and
an arithmetic logic unit electrically connected to said light-sensing units and adapted to convert the intensity of said first absorbed light, said second absorbed light or said third absorbed light being measured by said light-sensing units into a value indicative of the concentration of protein in said test sample

2. The protein assay apparatus as claimed in claim 1, wherein the number of said light-emitting units is 3 and these three light-emitting units are adapted to emit said first light, said second light and said third light respectively, and one of these three light-emitting units is selected to emit one of said first light, said second light and said third light at one time point.

3. The protein assay apparatus as claimed in claim 2, wherein said first light has a wavelength in the range of 552 nm˜572 nm; said second light has a wavelength in the range of 585 nm˜605 nm; said third light has a wavelength in the range of 650 nm˜670 nm.

4. The protein assay apparatus as claimed in claim 1, further comprising at least one optical fiber connected to said light-emitting units.

5. The protein assay apparatus as claimed in claim 4, further comprising a light outlet element connected to said light-emitting units through said at least one optical fiber.

6. The protein assay apparatus as claimed in claim 1, further comprising a first carrier carrying said light-emitting units, and a second carrier carrying said at least one light-sensing unit corresponding to said light-emitting units at said first carrier.

7. The protein assay apparatus as claimed in claim 6, further comprising a first transparent plate located at said first carrier and covering said light-emitting units, and a second transparent plate located at said second carrier and covering said at least one light-sensing unit.

8. The protein assay apparatus as claimed in claim 1, further comprising a first carrier and a second carrier, said first carrier and said second carrier being disposed corresponding to each other.

9. The protein assay apparatus as claimed in claim 8, further comprising a light outlet element and a light inlet element, said light outlet element being located at said first carrier and connected to said light-emitting units by at least one first optical fiber, said light inlet element being located at said second carrier and connected to said at least one light-sensing unit by at least one second optical fiber.

10. The protein assay apparatus as claimed in claim 9, further comprising a first transparent plate and a second transparent plate, said first transparent plate being located at said first carrier and covering said light outlet element, said second transparent plate being located at said second carrier and covering said light inlet element.

11. The protein assay apparatus as claimed in claim 10, wherein said test sample is placed between said first transparent plate and said second transparent plate.

12. The protein assay apparatus as claimed in claim 1, wherein said first light has a wavelength in the range of 552 nm˜572 nm; said second light has a wavelength in the range of 585 nm˜605 nm; said third light has a wavelength in the range of 650 nm˜670 nm.

13. A protein assay apparatus, comprising:
a light-emitting unit controllable to emit a first light, a second light or a third light onto a test sample, wherein said first light is a green light, said second light is a yellow light, and said third light is a red light;
a light-sensing unit adapted to receive a first absorbed light, a second absorbed light or a third absorbed light and to measure the intensity of said first absorbed light, said second absorbed light and said third absorbed light, wherein said test sample absorbs part of said first light, said second light or said third light to generate said first absorbed light, said second absorbed light or said third absorbed light; and
an arithmetic logic unit electrically connected to said light-sensing unit and adapted to convert the intensity of said first absorbed light, said second absorbed light and said third absorbed light being measured by said light-sensing unit into a value indicative of the concentration of protein in said test sample.

14. The protein assay apparatus as claimed in claim 13, wherein said first light has a wavelength in the range of 552 nm˜572 nm; said second light has a wavelength in the range of 585 nm˜605 nm; said third light has a wavelength in the range of 650 nm˜670 nm.
